(19) United States
(12) Patent Application Publication
(10) Pub. No.: US 2004/0190812 A1
(43) Pub. Date: Sep. 30, 2004

(54) Refractive index probe apparatus and system

(76) Inventors: Lee Allen Barger, Durham, NC (US); John Joseph Partridge, Chapel Hill, NC (US); Dwight Sherod Walker, Durham, NC (US)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/490,683

(22) PCT Filed: Oct. 3, 2002
(86) PCT No.: PCT/US02/31470

(30) Foreign Application Priority Data
Oct. 5, 2001 (US) 60327706

(51) Int. Cl. G02B 6/00

(52) U.S. Cl. 385/12

(57) ABSTRACT

A refractive index device (10) comprising a probe member (16) having a sensing region (24) and a length of optic fiber (40) having a refract region (44) and a reflecting surface (48) disposed proximate the distal end adapted to substantially redirect said light transmitted through the fiber, the fiber being substantially disposed in the probe member wherein the refract region (44) is disposed proximate the sensing region (24).

### FIELD OF THE PRESENT INVENTION

The present invention relates generally to fiber optic based sensors. More particularly, the invention relates to a fiber optic probe to detect the refractive index and changes thereto of a surrounding medium.

### BACKGROUND OF THE INVENTION

In many processes, it is required to detect changes in the state of a fluid or other substance (i.e., medium), which may be either discontinuous changes in the state of the medium (e.g., presence or absence of a liquid) or continuous changes in the physical or chemical properties of the medium (e.g., the concentration of a solution or of one of the constituents of a composite fluid, or temperature variations of a fluid). Such detection may be used for various applications such as carrying out measurements, control or testing operations and regulation.

It has already been proposed, when a correlation exists between the characteristics of the medium and its refractive index, to detect the changes in these characteristics by detecting variations of this refractive index by means of various optical methods. Most of the optical methods are based on exploiting the reflection and refraction phenomena that occur near the critical angle. They essentially consist of transmitting light through a transparent light-conducting structure immersed in the medium, so that light undergoes multiple internal reflections on the walls of the structure. The determination of the intensity of the light thus transmitted by multiple reflections and the sudden variations of this intensity near the critical angle thus permits the refractive index of the medium to be determined.

To make continuous refractive index measurements there are, for example, sensors of the type consisting of a straight transparent rod with an optic-mechanical system at one end for injecting a pencil of light into the rod with a well-defined angle of incidence, and with a photo-electric detector at its other end for measuring the intensity of the light thus transmitted through the rod by multiple internal reflections with a well-defined angle of incidence. When the rod is immersed in the medium to be measured, the angle of incidence of the pencil of light injected into the rod is then made to decrease continuously while observing the transmitted-light intensity; the sudden drop in intensity which occurs when the angle of incidence of the multiple reflections exceeds the critical angle with respect to the medium permits this critical angle to be determined and, hence, the refractive index of the medium.

Sensors of this type have a major drawback of being extremely complicated given that they require, among other things, a relatively sophisticated light-injection system that must ensure both a parallel pencil of incident light by optical means and a continuous variation of the angle of incidence of this pencil by mechanical means.

Other known sensors employ one or more conventional optical fibers. The optical fibers typically include a light transmitting optical fiber core of glass, an outer clad layer having a different refractive index from the core to prevent optical loss from the core (e.g., doped glass), and an outer protective layer (e.g., plastic). Illustrative is the sensors disclosed in U.S. Pat. Nos. 4,851,817, 5,005,005, 5,995,686 and 5,026,134.

In U.S. Pat. Nos. 4,851,817 and 5,005,005 (Brossia, et al.) a sensor is disclosed having an optical fiber with portions of both the outer protective layer and the cladding layer removed, exposing the core. The exposed core is provided with striations via abrading or sanding with a piece of sandpaper or the like. According to the invention, the surface irregularities cause light to refract out of the fiber and into the surrounding medium, with the amount of light lost being dependent on the refractive index of the surrounding medium. A photo-detector senses the amount of light transmitted along the fiber past the striated portion. Changes in the amount of light transmitted provide an indication of changes in the surrounding medium.

A major drawback of the noted sensor is that the optical loss through a length of bare fiber core is very high. Thus, the sensor is only capable of detecting gross changes in the refractive index of a surrounding medium.

In U.S. Pat. No. 5,995,686 a similar sensor is disclosed wherein only a portion of the outer protective layer is removed. The exposed portion of the clad layer is also “roughened” to provide scratches that extend through the clad layer.

Although the noted sensor is more sensitive than the sensors disclosed in the '817 and '005 patents, the sensitivity of the sensor is directly dependent on the characteristics of the scratches, which can, and in most instances will, vary from sensor to sensor.

In U.S. Pat No. 5,026,139 a sensor is disclosed having a fiber optic core with a porous, thin film metal clad that produces a controlled leakage of light as a function of the refractive index of the surrounding medium. A drawback of this sensor is that different clad materials must be chosen for specific analyses.

It is therefore an object of the present invention to provide a fiber optic refractive index probe that overcomes the above-discussed deficiencies with conventional optic-based sensors.

It is another object of the invention to provide a refractive index probe for in situ detection of the refractive index and changes thereto of a multitude of different liquids and solids, and mixtures thereof, including, chemical reaction products, chemical solutions, solvents and solvent mixtures, and other substances.

It is yet another object of the present invention to provide a refractive index probe that provides direct, real-time measurements of azeotropic distillation streams.

### SUMMARY OF THE INVENTION

In accordance with the above objects and those that will be mentioned and will become apparent below, the refractive index apparatus in accordance with this invention comprises (i) a probe member having a sensing region; and (ii) a length of optic fiber having a refract region and a reflecting surface disposed proximate one end adapted to substantially redirect said light transmitted through the fiber, the fiber being substantially disposed in the probe member wherein the refract region is disposed proximate the sensing region.

The refractive index system of the invention comprises (i) a light source; (ii) a probe member having a sensing region; (iii) a length of optic fiber adapted to transmit light from the light source through the fiber, the fiber including a refract region and a reflecting surface disposed proximate the distal end adapted to substantially redirect light transmitted through the fiber, the fiber being substantially disposed in the probe extension wherein the refract region is disposed proximate the sensing region; and (iv) a detector for detecting the amount of light redirected through the fiber.

The method of detecting the refractive index of a medium, in accordance with the invention, comprises (i) placing a probe member in the medium, the probe member having a sensing region and a length of optic fiber having first and second ends substantially disposed in the probe member, the optic fiber including a refract region disposed between the first and second ends and a reflecting surface disposed proximate the second end, the refract region being disposed proximate the sensing region; (ii) transmitting light into the first end of the optic fiber and through the optic fiber in a first direction wherein a first portion of the light is transmitted through the sensing region into and through the medium; (iii) redirecting the light with the reflecting surface through the optic fiber in a second direction wherein a second portion of the light is transmitted through the sensing region into and through the medium; (iv) detecting the intensity of the light received at the first end of said optic fiber; and (v) determining the refractive index of the medium using the detected light intensity.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is an exploded perspective view of one embodiment of the refractive index probe according to the invention;

FIG. 2 is an assembled perspective view of the refractive index probe shown in FIG. 1 according to the invention;

FIG. 3 is a partial perspective view of a prior art optic fiber;

FIG. 4 is an exploded, partial perspective view of one embodiment of the optic fiber, illustrating the reflective means according to the invention;

FIG. 5 is a partial plan view of the optic fiber shown in FIG. 4, illustrating the refract region according to the invention;

FIG. 6 is a partial section plan view of the probe connector according to the invention;

FIG. 7A is a partial perspective view of one embodiment of a first section of the probe extension according to the invention;

FIG. 7B is a partial side plan view of the first probe extension section shown in FIG. 7A according to the invention;

FIG. 8A is a partial perspective view of a further embodiment of a first section of the probe extension according to the invention;

FIG. 8B is a partial side plan view of the first probe extension section shown in FIG. 8A according to the invention;

FIG. 9 is an end plan view of the first section of the probe extension shown in FIGS. 7B and 8B according to the invention;

FIG. 10 is a schematic illustration of the analyzer and refractive index probe assembly according to the invention;

FIG. 11 is a perspective illustration of the refractive index probe immersed in a medium according to the invention; and

FIG. 12 is a graph of voltage detected by the refractive index probe of the invention versus calculated refractive index (ri) of a changing medium.

### DETAILED DESCRIPTION OF THE PREFERRED EMBODIMENT

The refractive index probe of the present invention substantially reduces or eliminates the drawbacks and shortcomings associated with prior art optic-based sensors. The refractive index probe generally includes a probe connector, a probe extension and an optic fiber adapted to provide light to a surrounding medium. By the term “medium”, as used herein, it is meant to mean a surrounding or enveloping liquid or solid or mixture thereof, including, but not limited to, chemical solutions and formulations, solvents and solvent mixtures, and distillation streams.

As discussed in detail below, the refractive index probe provides significant improvements in sensitivity and signal-to-noise ratio compared to prior art sensors. The probe also facilitates direct, real-time “on-line” assessments of fluids and other substances and access to a medium through narrow passages.

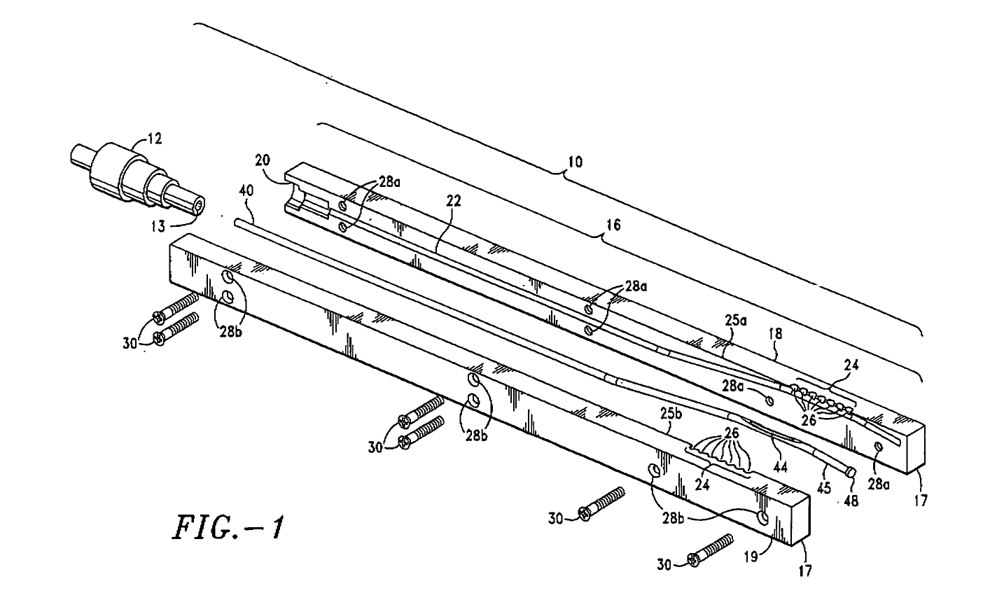

Referring first to FIG. 1, there is shown an exploded perspective view of one embodiment of the refractive index probe 10. The probe 10 includes a probe connector 12, a probe extension 16 and an optic fiber 40. As illustrated in FIG. 1, the probe extension 16 preferably comprises substantially similar first 18 and second 19 elongated sections.

According to the invention, virtually any conventional optic fiber can be employed within the scope of the invention. As illustrated in FIG. 3, such fibers typically include a light transmitting fiber core 41 of fused silica or the like, a clad layer 42 for preventing or restricting transmission of light out of the core 41, and a protective outer layer 43 of plastic or like material. In a preferred embodiment of the invention, the fiber 40 includes a silica core 41, a silica or gel clad layer 42 and a polymer (e.g., Aramid®, Teflon®) outer layer 43.

As is well known in the art, two distinct bend radius values are generally associated with optic fibers, i.e., momentary radius (R_{M}) and long term radius (R_{LT}). The noted radii are typically determined from the following relationships:

R_{M}=M_{M}×R_{C} Eq. 1

where

M_{M}=momentary coefficient (or multiplier), which is generally ≦100, and

R_{C}=clad radius;

and

R_{LT}=M_{LT}×R_{C} Eq. 2

where

M_{LT}=long term coefficient, which is generally ≦600.

According to the invention, the clad radius (R_{C}) of the optic fiber 40 of the invention can range from 10 μm to 0.1 cm; provided, the momentary radius (R_{M}) is less than approximately R_{C}×100 and the long term radius (R_{LT}) proximate the refract region 44 (discussed in detail below) is less than approximately R_{C}×600. More preferably, the long term radius proximate the refract region 44 is in the range of 9.5 cm to 10.5 cm.

As is further well known in the art, the principle of operation of an optic fiber depends on the refractive index of the material at the core interface. In order for the core to transmit light efficiently, the core must be clad with a material of lower refractive index than the core. With the clad layer removed, light is transmitted very inefficiently. As the core is placed into various media, the light is transmitted with an efficiency that depends on the refractive index of the medium. The medium, in essence, becomes the clad layer. The lower the refractive index of the medium, the more light is transmitted through the core. If the medium has a higher refractive index than the core, then no reflection will occur and all the light will be lost.

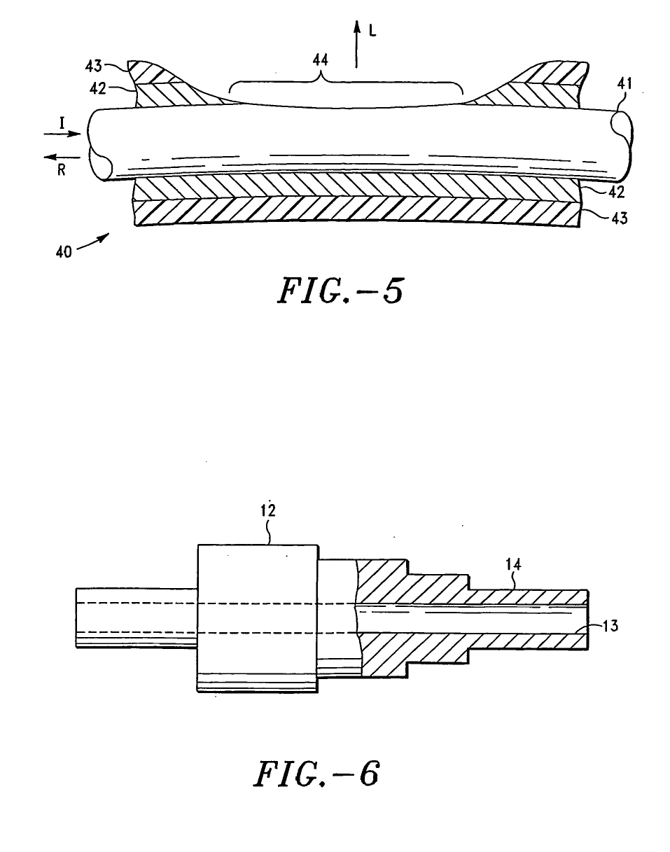

Referring now to FIG. 5, in accordance with the invention, the optic fiber 40 further includes a refract region 44 adapted to transmit (or release) light to the surrounding medium. As illustrated in FIG. 5, the refract region 44 is preferably provided by removing portions of the outer layer 43 and clad layer 42 to substantially expose the core 41. In a preferred embodiment of the invention, approximately 20-40% of the core 41 is also removed to provide a substantially smooth, flat, and preferably oval shaped refract region 44.

According to the invention, the length of the refract region 44 over which the outer layer 43 and clad layer 42 (and, in a preferred embodiment, core 41) are removed is in the range of 0.1-5.0 cm. In a preferred embodiment of the invention, the length of the refract region 44 is substantially equal to the length of the sensing region 24 of the probe extension 16 (discussed in detail below).

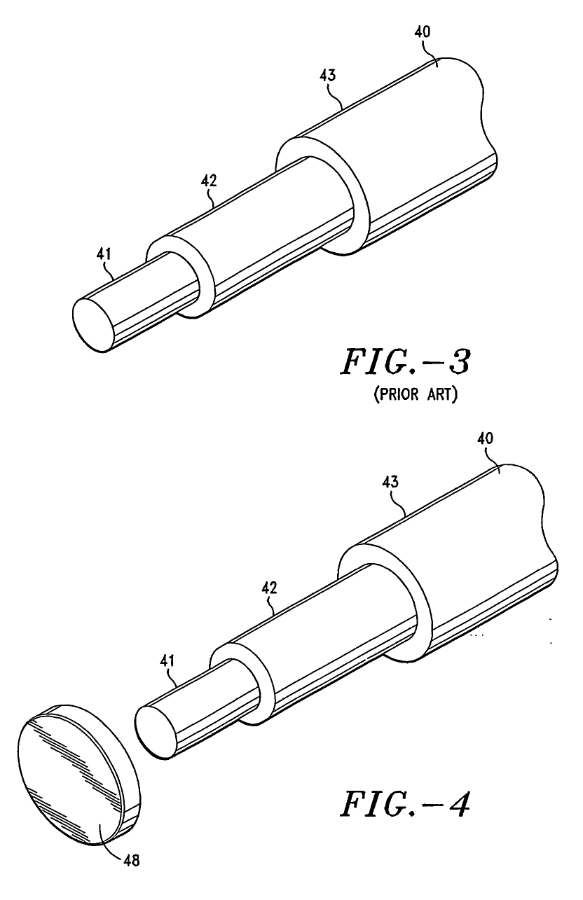

Referring now to FIG. 4, the optic fiber 40 also includes a mirror 48 or other reflecting means (i.e., reflecting surface) disposed proximate the distal end 45 of the optic fiber 40. As discussed in detail below, the mirror 48 is positioned and adapted to reflect and, hence, redirect light transmitted into and through the optic fiber 40.

Referring now to FIG. 6, there is shown a partial sectional plan view of the probe connector 12. As illustrated in FIG. 6, the probe connector 12 includes a lumen 13 therethrough adapted to receive the optic fiber 40.

As will be appreciated by one having ordinary skill in the art, the probe connector 12 can comprise various shapes and be constructed out of various materials. In a preferred embodiment, the probe connector 12 is constructed of a material that is substantially impervious to volatile and/or corrosive materials, such as stainless steel.

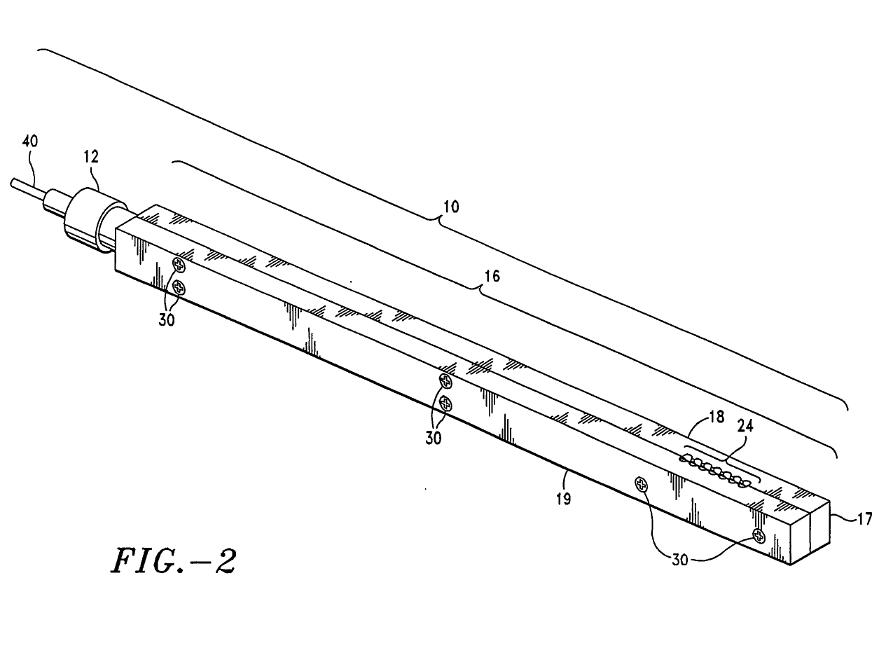

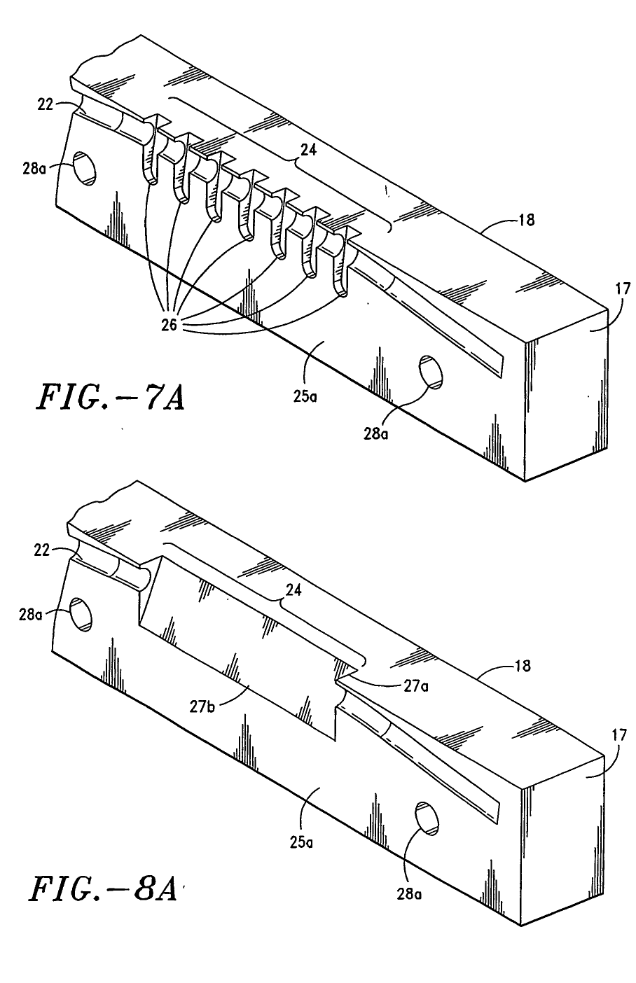

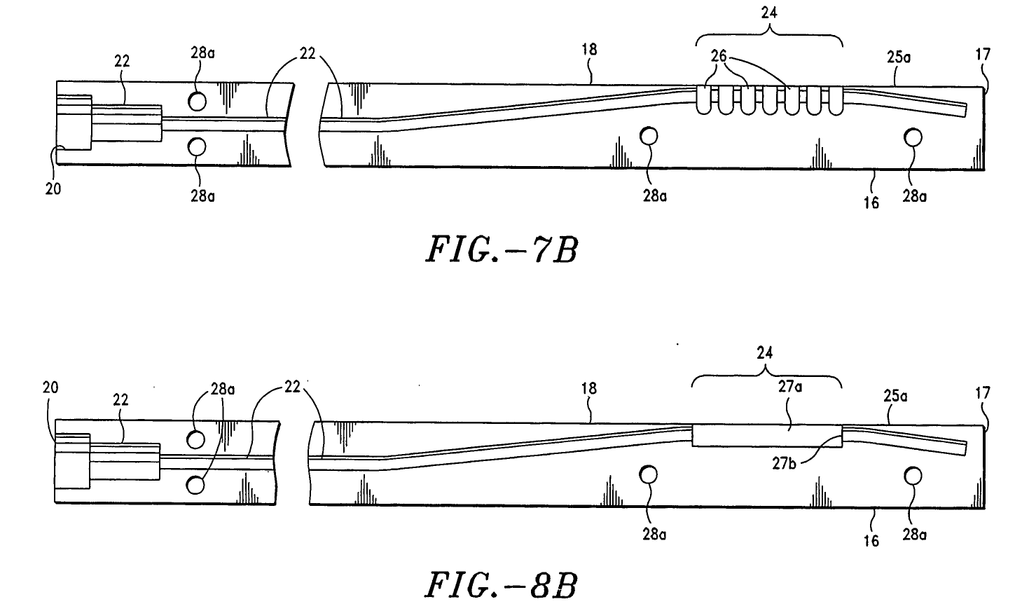

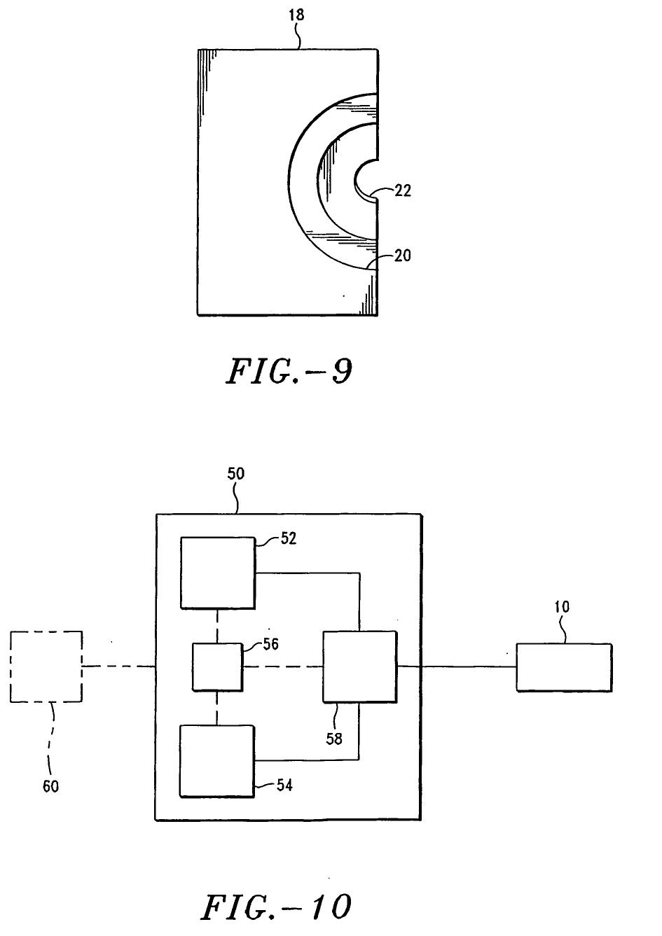

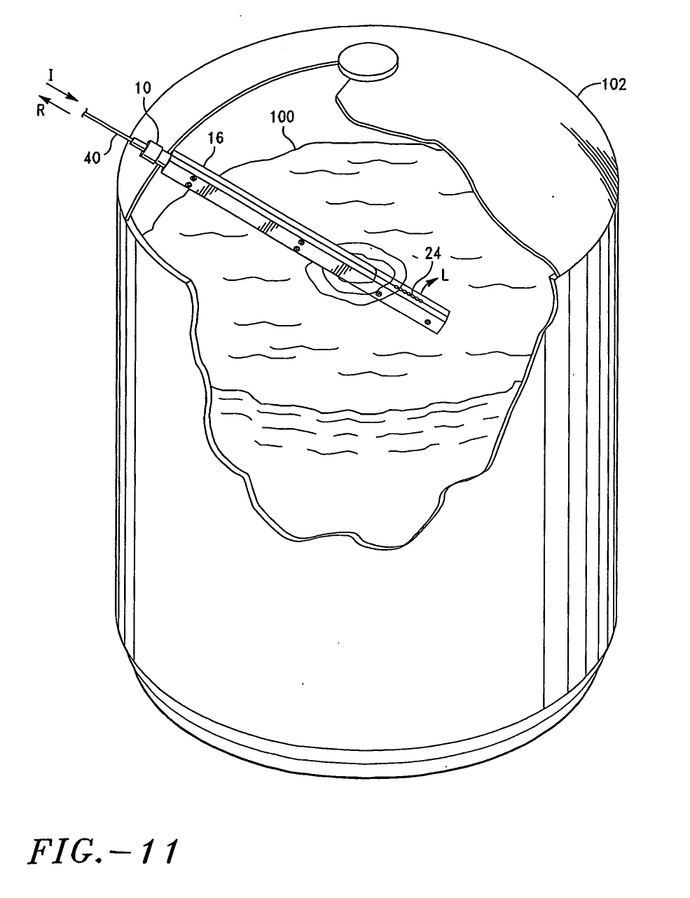

Referring now to FIGS. 7A and 7B, there is shown the first section 18 of the probe extension 16 shown in FIGS. 1 and 2. For simplicity, only the first section 18 will be described in detail. However, it is to be understood that the second section 19 of the probe extension 16 is preferably similarly constructed and the description of the first section 18 is equally applicable to both sections 18, 19.

As illustrated in FIG. 7B, the first section 18 of the probe extension 16 includes a probe connector seat 20 on one end adapted to receive the front end 14 of the probe connector 12 (see FIG. 2). The first section 18 further includes an optic fiber seat or recess 22 adapted to receive the optic fiber 40. The optic fiber seat 22 preferably extends from the probe connector seat 20 to the distal end 17 of the first section 18.

Referring to FIGS. 2 and 7A, also disposed proximate the distal end 17 of the first section 18 is a sensing region 24. According to the invention, the sensing region 24 is substantially aligned with and, hence, cooperates with the refract region 44 of the optic fiber 40 to facilitate transmission (or release) of light from the optic fiber 40 to a surrounding medium.

Referring now to FIGS. 7A and 8A, in accordance with the invention, the sensing region 24 can comprise various sizes and configurations to provide an “active sensing area” in the range of 0.01-0.30 cm². In a preferred embodiment, the sensing region 24 has a substantially similar shape as the refract region 44, a maximum length in the range of 0.1-5.0 cm, more preferably, 1.0-2.0 cm, and a maximum width in the range of 0.01-0.1 cm.

As illustrated in FIGS. 7A and 7B, in one embodiment of the invention, the sensing region 24 also includes a plurality of slots (or cut-outs) 26 disposed proximate the edges of opposing sides 25a, 25b. According to the invention, the slots 26 are designed and adapted to facilitate effective engagement of the optic fiber 40 to the probe extension 16, which is preferably achieved via a conventional epoxy.

Referring now to FIGS. 8A and 8B, there is shown another embodiment of the invention wherein the edges on the opposing sides 25a, 25b of the sensing region 24 are substantially chamfered or beveled (designated generally 27a). The chamfered section 27a also includes an engagement region 27b disposed proximate the lower portion of the chamfered section 27a that is similarly adapted to facilitate engagement (e.g., epoxy bonding) of the optic fiber 40 to the probe extension 16.

According to the invention, the size and number of the slots 26 (and the angle thereof) in the embodiment shown in FIGS. 7A and 7B, and the size of the chamfered region 27a and the angle thereof in the embodiment shown in FIGS. 8A and 8B can also be selected to provide desired patterns of refracted light.

As stated and shown in FIGS. 7A and 8A, the first and second sections 18, 19 of the probe extension 16 are preferably similarly constructed (i.e., substantially similar mirror images on the adjoining faces 25a, 25b). However, in additional envisioned embodiments of the invention, a substantial portion of the optic fiber recess 22 can be disposed in one section (e.g., first section 18) to receive and secure the optic fiber 40 during assembly.

Referring back to FIG. 1, the first and second sections 18, 19 of the probe extension 16 also include a plurality of substantially aligned holes 28a, 28b adapted to receive engagement screws 30. According to the invention, each hole 28b on the second section 19 preferably includes threads to threadably engage a respective engagement screw 30, securing the first and second probe extension sections 18, 19 together (see FIG. 2).

As will be appreciated by one having ordinary skill in the art, various additional conventional means may be employed to secure the first and second probe extension sections 18, 19. Such means include conventional snap closures and epoxy.

In accordance with the invention, the probe extension 16 is preferably constructed of a high strength material that is substantially chemically inert, such as stainless steel, high density polyethylene, and polyetheretherketone (PEEK™). In a preferred embodiment of the invention, the probe extension 16 is constructed of PEEK™.

As will be appreciated by one having ordinary skill in the art, unlike prior art sensors with substantially exposed optic fibers, the probe extension 16 provides a further layer of protection for the optic fiber 40 and, hence, substantially enhances impact resistance of the probe 10.

As will further be appreciated by one having ordinary skill in the art, by virtue of the glass core 41, the stainless steel probe connector 12, and the PEEK™ probe extension 16, the refractive index probe 10 described herein can be employed in most hostile, volatile and corrosive environments without adversely effecting the performance of the probe 10. It will also be appreciated that since the probe extension 16 has a relatively small cross section (e.g., 0.25-1 cm²) and can comprise various lengths (e.g., 5-100 cm) the probe 10 can be readily employed at a multitude of “on-line” sites.

Referring now to FIGS. 10 and 11, operation of the refractive index probe 10 will be described in detail. According to the invention, the probe 10 is in communication with an analyzer 50 via the optic fiber 40. As illustrated in FIG. 10, the analyzer 50 preferably includes a light source 52 for providing light to the optic fiber 40, a detector 54 for detecting light transmitted back through the optic fiber 40 and producing at least one output signal corresponding thereto, and control means 56 adapted to control the operation of the light source 52, detector 54, and beam splitter 58, discussed below.

In accordance with the invention, light (e.g., UV/visible through near-infrared) from the light source 52 is transmitted to a beam splitter 58. The beam splitter 58 can be integral with the analyzer 50, as shown in FIG. 10, or a separate component. The light is then split by the beam splitter 58 and transmitted into and through the optic fiber 40.

The light traverses the optic fiber 40 in a first direction (e.g., see Arrow I in FIGS. 5 and 11) to the refract region 44 where light refracts out of the optic fiber 40 (and sensing region 24) to the surrounding medium 100 contained in the mixer (or other “on-line” containment means) 102 (see FIG. 11). As will be understood by one having skill in the art, the amount of light that is refracted or lost (designated generally by Arrow L) is a function of the localized index of the medium 100.

The light that remains in the optic fiber 40 is reflected back through the optic fiber 40 in a second direction (see Arrow R in FIG. 5) by virtue of the mirror 48 disposed proximate the distal end 45 of the optic fiber 40 (see FIG. 4). The reflected light is thus transmitted past the refract region 44 a second time, wherein a second portion of the light refracts out of the optic fiber 40 and sensing region 24, and the remaining reflected light is transmitted back to the beam splitter 48. The beam splitter 48 then directs the reflected light to the detector 54 where an output signal corresponding to the reflected light (i.e., light intensity) is provided. The output signal is then correlated to the refractive index of the medium 100 by conventional means.

As illustrated in Example 1, the noted “double pass” fiber optic technique provides a sensitivity level of at least ±0.005, which is unparalleled in the art. The “double pass” technique also substantially improves the signal-to-noise ratio compared to multiple-fiber sensors.

As illustrated in FIG. 10, in additional embodiments of the invention, the analyzer 50 includes display means (shown in phantom and designated 60) adapted to display detected characteristics of the medium 100 and other pertinent information.

As will be appreciated by one having ordinary skill in the art, the refractive index probe 10 of the invention provides direct, real-time means of determining the refractive indices (and changes thereto) of a multitude of mediums (e.g., liquids, chemical solutions and solvents). The probe 10 is particularly useful for: (i) providing direct, real-time measurements of solvent ratios in both atmospheric and vacuum distillation streams; (ii) providing direct, real-time measurements of azeotropic distillation streams (e.g., removal of water or methanol or ethanol from reaction mixtures containing primarily aprotic, polar or non-polar solvents, such as acetonitrile, dioxane, ethyl acetate, methylene chloride, toluene, etc., by azeotropic distillation); (iii) providing direct, real-time azeotropic measurements of distilled fermented beverage precursors (e.g., ethanol-water processors to bourbon, kirsh, rum, whiskey, etc.). The probe of the invention can also be employed to monitor “solvent swaps” in primary chemical manufacturing (e.g., replacing methylene chloride or methanol with ethyl acetate, replacing methylene chloride or methanol or ethanol or ethyl acetate with dimethyl formamide, etc.). The noted uses are deemed novel and, hence, form a further aspect of the invention.

The probe of the invention can also be attached to or employed as an integral component of a mixing apparatus (e.g., mixing blade).

The following Example is for illustrative purposes only and is not meant to limit the scope of the invention in any manner.

### EXAMPLE 1

A refractive index probe of the invention, having the following parameters, was employed in the example set forth below:

Active sensing area=˜0.066 cm²

Long term radius of optic fiber=33.8 cm

The noted refractive index probe was placed into a volume beaker of toluene, having a refractive index of 1.494, along with a stir bar on a magnetic stirrer. Using a syringe pump, an equal volume of acetic acid, having refractive index of 1.370, was added over a period greater than 6 hours. During this time, the voltage measured by the refractive index probe was transmitted to a computer.

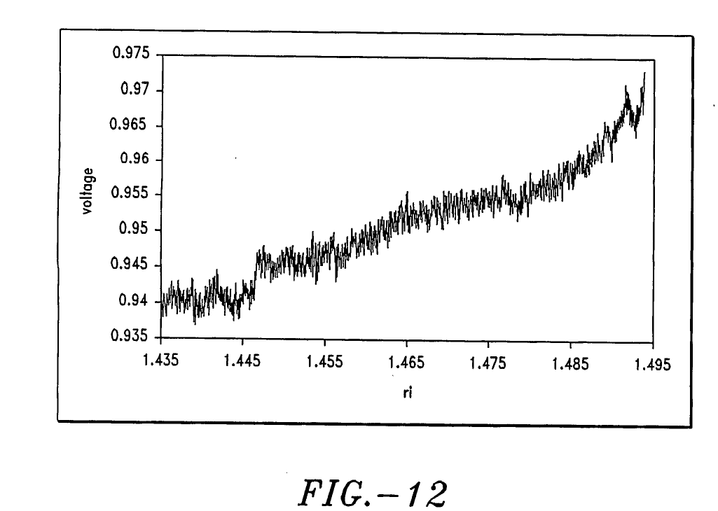

Referring now to FIG. 12, there is shown a graph of the voltage measured by the refractive index probe and a calculated refractive index. The refractive index was calculated by measuring the initial refractive index (ri) of the solvent with a volume fraction of the second solvent's refractive index, i.e.,

ri_{measured}=riₛₜₐᵣₜ+ri_{added}*(volume_{added}/volumeₜₒₜₐₗ). Eq. 3

As illustrated in FIG. 12, the voltage measured by the probe accurately and effectively tracks the refractive index of the solvent. It can further be seen that as the refractive index of the medium is reduced by dilution, the index diverges further from the refractive index of the optic fiber core (i.e., approx. 1.467). The probe thus “leaks” more light into the bulk medium.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A refractive index device, comprising:
a probe member, said probe member having a sensing region; and
a length of optic fiber adapted to transmit light through said optic fiber, said optic fiber having first and second ends, said optic fiber including a refract region disposed between said first and second ends of said optic fiber and a reflecting surface disposed proximate said second end, said reflecting surface being adapted to substantially redirect said light transmitted in a first direction through said optic fiber in a second direction through said optic fiber,
said optic fiber being substantially disposed in said probe member whereby said refract region is proximate said sensing region.

2. The device of claim 1, wherein a first portion of said light is transmitted through said refract region when said light is transmitted through said optic fiber in said first direction and a second portion of said light is transmitted through said refract region when said light is transmitted through said optic fiber in said second direction.

3. The device of claim 1, wherein the length of said refract region is in the range of approximately 0.1-5.0 cm.

4. The device of claim 1, wherein the width of said refract region is in the range of approximately 0.01-0.1 cm.

5. The device of claim 1, wherein said probe member has a sensitivity level of at least approximately ±0.005.

6. The device of claim 1, wherein said probe member is constructed of polyetheretherketone (PEEK™).

7. The device of claim 1, wherein said probe member includes a connector adapted to receive said optic fiber.

8. The device of claim 1, wherein said reflecting surface comprises a mirror.

9. A refractive index device, comprising:
a length of optic fiber adapted to transmit light through said optic fiber, said optic fiber having first and second ends, said optic fiber including a refract region disposed between said first and second ends of said optic fiber and a reflecting surface disposed proximate said second end, said reflecting surface being adapted to substantially redirect said light transmitted in a first direction through said optic fiber in a second direction through said optic fiber;
a probe connector adapted to receive said optic fiber; and
a probe extension having a sensing region, said optic fiber being substantially disposed in said probe extension whereby said refract region is proximate said sensing region.

10. The device of claim 9, wherein a first portion of said light is transmitted through said refract region when said light is transmitted through said optic fiber in said first direction and a second portion of said light is transmitted through said refract region when said light is transmitted through said optic fiber in said second direction.

11. The device of claim 9, wherein the maximum length of said sensing region is in the range of approximately 0.1-5.0 cm.

12. The device of claim 11, wherein the maximum length of said sensing region is in the range of approximately 1.0-2.0 cm.

13. The device of claim 9, wherein the maximum width of said sensing region is in the range of approximately 0.01-0.1 cm.

14. The device of claim 9, wherein said probe extension has a cross-section less than approximately 1 cm².

15. The device of claim 9, wherein the sensitivity level of said refractive index is in the range of approximately ±0.005.

16. The device of claim 9, wherein said probe member is constructed of polyetheretherketone (PEEK™).

17. The device of claim 9, wherein said reflecting surface comprises a mirror.

18. A refractive index probe system, comprising:
a light source;
a probe member, said probe member including a sensing region;
a length of optic fiber having first and second ends adapted to transmit light from said light source through said optic fiber, said optic fiber including a refract region disposed between said first and second ends of said optic fiber and a reflecting surface disposed proximate said second end, said reflecting surface being adapted to substantially redirect said light transmitted in a first direction through said optic fiber in a second direction through said optic fiber, said optic fiber being substantially disposed in said probe member wherein said refract region is disposed proximate said sensing region; and
a detector in communication with said optic fiber for detecting the amount of light transmitted in said second direction through said optic fiber.

19. The probe system of claim 18, wherein a first portion of said light is transmitted through said refract region when said light is transmitted through said optic fiber in said first direction and a second portion of said light is transmitted through said refract region when said light is transmitted through said optic fiber in said second direction.

20. The probe system of claim 18, wherein the maximum length of said sensing region is in the range of approximately 1.0-2.0 cm.

21. The probe system of claim 18, wherein the maximum width of said sensing region is in the range of approximately 0.01-0.1 cm.

22. The probe system of claim 18, wherein said refractive index probe system has a sensitivity level in the range of approximately ±0.005.

23. A method of detecting the refractive index of a medium, comprising the steps of:
placing a probe member in said medium, said probe member having a sensing region and a length of optic fiber having first and second ends substantially disposed in said probe member, said optic fiber including a refract region disposed between said first and second ends and a reflecting surface disposed proximate said second end, said refract region being disposed proximate said sensing region;
transmitting light into said first end of said optic fiber and through said optic fiber in a first direction wherein a first portion of said light is transmitted through said sensing region into and through said medium;
redirecting said light with said reflecting surface through said optic fiber in a second direction wherein a second portion of said light is transmitted through said sensing region into and through said medium;
detecting the intensity of the light received at said first end of said optic fiber; and
determining the refractive index of the medium using said detected light intensity.
